(19) United States
(12) Patent Application Publication
(10) Pub. No.: US 2022/0176404 A1
(43) Pub. Date: Jun. 9, 2022

(54) METHOD AND APPARATUS FOR COATING A NARROW SIDE OF A PLATE-SHAPED WORKPIECE

(71) Applicant: HOMAG GmbH, Schopfloch (DE)

(72) Inventor: Markus MORLOCK, Freudenstadt (DE)

(21) Appl. No.: 17/429,930

(22) PCT Filed: Feb. 7, 2020
(86) PCT No.: PCT/EP2020/053125

§ 371 Date: Feb. 28, 2022

(30) Foreign Application Priority Data
Feb. 11, 2019 (DE) 10 2019 103 267.9

(51) Int. Cl. B05D 5/06

(52) U.S. Cl. CPC B05D 5/061

(57) ABSTRACT

The invention relates to a method for coating a narrow side (1) of a plate-shaped workpiece (2) with a coating material (3), in particular a strip-shaped or band-shaped coating material (3), using a coating apparatus, wherein, before being applied to the narrow side (1) of the workpiece (2), the coating material (3) is colored with a basic color (4) at least in a peripheral area (5), which is assigned to an adhesive surface (6) of the coating material (3), or the coating material (3) is entirely colored with the basic color (4), wherein the basic color (4) is color-matched to a shade and/or pattern and/or decoration of a surface (8) of the workpiece (2) such that, after the coating material (3) has been applied to the narrow side (1) of the workpiece (2), a matched color transition between the colored coating material (3) and the shade and/or pattern and/or decoration of the surface (8) of the workpiece (2) is formed, and to a coating apparatus carrying out such a method.

### TECHNICAL FIELD

The invention relates to a method and to a coating apparatus for coating a narrow side of a plate-shaped workpiece.

### PRIOR ART

For the production of furniture parts or other components, chipboard material is often used, the surfaces of which are often provided with a coating material for functional reasons, and also to achieve a higher-quality visual and qualitative impression. A coating or edge material is in most cases also provided on the narrow sides.

A coating device with which workpieces for the furniture or components industry can be provided with a strip-shaped coating material, in particular in the area of the narrow sides, is known from DE 10 2015 206 010 A1. To enable precise application of the strip-shaped coating material to the narrow side of the workpiece, the coating device has a guiding device and a pressure device. Before the coating material is pressed against the narrow side, an adhesive provided on the coating material is uniformly activated such that constant adhesion values are ensured also in a start or end area of the coating material. In this way, edge protrusions and the associated material consumption can be reduced. However, only one coating material can be provided in this coating device, so that replacing the coating material leads to downtime.

DE 10 2016 224 488 A1 discloses a coating machine with a storage arrangement by means of which different types of coating materials can be applied to a narrow side of a plate-shaped workpiece. The storage arrangement accommodates a plurality of different coating materials so that, depending on a surface or decoration of the workpiece, a corresponding coating material can be taken from the storage arrangement and fed to the coating machine. In this way, the processing of workpieces with different patterns or decorations is possible, but a large number of different coating materials must be stored for this purpose.

EP 1 555 132 A2 discloses a machine for printing the narrow sides of plate-shaped workpieces. This machine has a workpiece receiving device that guides the previously coated workpieces with the narrow side to be printed along an ink-jet printing system. With this printing system, the narrow side of the workpieces can be printed in color or with a color pattern, but an additional coating device is required in addition to the printing machine. In addition, the printing machine requires a complex adjustment mechanism in order to be able to also print rounded narrow sides from all sides.

The invention is based on the object of proposing a method and an apparatus, by means of which a visually appealing and cost-efficient coating of workpieces, in particular in the area of the narrow side, is made possible.

This object is solved by a method for coating a narrow side of a plate-shaped workpiece with a coating material, in particular a strip-shaped or band-shaped coating material, using a coating apparatus, wherein, before being applied to the narrow side of the workpiece, the coating material is colored with a basic color at least in a peripheral area, which is assigned to an adhesive surface of the coating material, or the coating material is entirely colored with the basic color, wherein the basic color is color-matched to a shade and/or pattern and/or decoration of a surface of the workpiece such that, after the coating material has been applied to the narrow side of the workpiece, a homogeneous color transition between the colored coating material and the shade and/or pattern and/or decoration of the surface of the workpiece is formed. Using this method, a coated workpiece can be produced, in which the coating material applied to the narrow side is color-matched to the shade and/or pattern and/or decoration of a surface of the workpiece. In this way, a visually perceptible difference in color, in particular in the transition area, between the surface of the workpiece and the colored coating material applied to the narrow side can be avoided or at least minimized. Thus, a high-quality visual impression of the coated workpiece can be achieved.

A preferred further development of the method provides that the coating material is colored with the basic color before being fed to the coating apparatus, or the coating material is colored with the basic color by a coloring device of the coating apparatus. Since the coating material is fed to the coating apparatus already in the colored state, simple integration in an existing coating process can be provided. Likewise, a coloring device may be provided upstream of the coating process, by which the coating material is colored before being applied to the workpiece. This also allows the coating material to be colored with different basic colors before being applied to the narrow side of the workpiece. In this way, color matching to different shades and/or patterns and/or decorations of the surface of the workpiece can be enabled with only one coating material. Storage with different coating materials can thus be avoided or at least reduced. If necessary, downstream drying may be required.

A further advantageous configuration of the method provides that the coating apparatus is provided with a plurality of coating materials colored with different basic colors, wherein one of the coating materials whose basic color is color-matched to the shade and/or pattern and/or decoration of the surface of the workpiece is fed to the coating apparatus for coating the narrow side of the workpiece. Reduced storage with different coating materials can thus be provided. This can be achieved by matching the basic colors of the respective coating materials at least approximately to the various shades and/or patterns and/or decorations of the workpieces to be processed. A coating material having a basic color can thus be used for shades and/or patterns and/or decorations of the workpieces, which are different, but are comparable, or differ only slightly, in terms of color.

In a particularly preferred further development of the method, it can be provided that the coating material, in particular a narrow surface opposite the adhesive surface and extending along the coating material and/or at least one edge portion of the coating material adjacent along the narrow surface, is printed after application to the narrow side of the workpiece with a printing device having at least one printing stage. This allows a visible area of the coating material to be printed with one or more printing dyes. In addition, a multi-layer dye application can be provided by several successive printing stages. In this way, the coating material can be printed with a pattern and/or decoration that corresponds to the pattern and/or decoration of the surface of the workpiece. By this printing of the coating material, a visually appealing edge of the workpiece can be formed. This makes it possible to achieve the visual impression that the workpiece is formed from a uniform material.

An advantageous configuration of the method provides that the coating material is printed inline in the coating device with the printing device and that an active drying process of the printing dyes occurs preferably after each printing stage. By integrating the printing device in the coating device, an efficient coating process can be achieved in which all method steps are carried out by the coating device. Additional, in particular manual, processing steps are not required. As a result, a significant reduction in the manufacturing costs for such a coating can be achieved.

In a further development of the method, it can be provided that the shade and/or pattern and/or decoration of the surface of the workpiece is detected by a sensor device, and a coating material with a color-matched basic color is automatically fed to the coating apparatus based on the detected shade and/or pattern and/or decoration, and/or the printing device is controlled by the sensor device such that the coating material is printed with a pattern and/or decoration which is matched to the detected shade and/or pattern and/or decoration. By providing such a sensor device, a fully automated or at least partially automated coating method can be provided.

The object is further solved by a coating apparatus for coating a narrow side of a plate-shaped workpiece with a coating material, in particular a strip-shaped or band-shaped coating material, using a feeding device for feeding the coating material to the narrow side of the workpiece and a coating unit for applying the coating material to the narrow side of the workpiece, wherein the coating apparatus carries out the method for coating a narrow side of a plate-shaped workpiece with a coating material according to one of the previously described embodiments. Using a coating apparatus carrying out such a method, plate-shaped workpieces for furniture parts or other components can be formed in which a visually appealing and high-quality coating of the narrow side of the workpiece is provided. This is achieved by feeding a coating material to the coating apparatus, which is at least partially colored with a basic color that is color-matched to a shade and/or pattern and/or decoration of a surface of the workpiece. By the subsequent printing of the coating material, which is matched to the shade and/or pattern and/or decoration of the surface of the workpiece, this visually appealing and high-quality impression can be additionally enhanced.

The invention and further advantageous embodiments and further developments thereof will be described and explained in more detail below on the basis of the examples shown in the drawings. The features that are apparent from the description and the drawings can be applied individually or jointly in any combination in accordance with the invention. The drawings show the following:

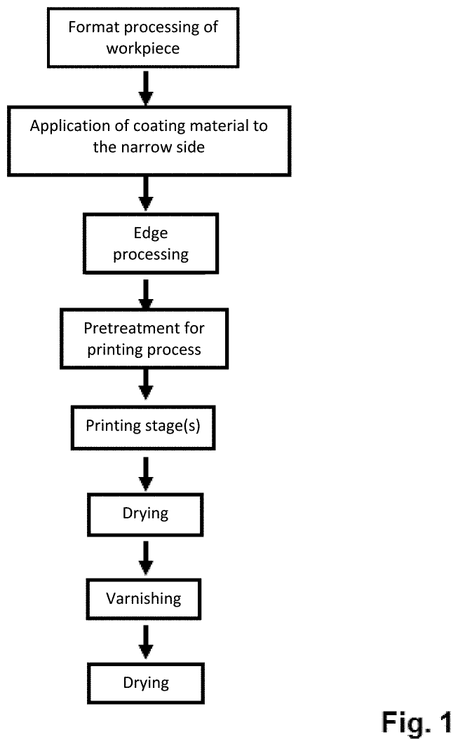

FIG. 1 shows a flow chart of a method for coating a narrow side of a workpiece with a coating material,

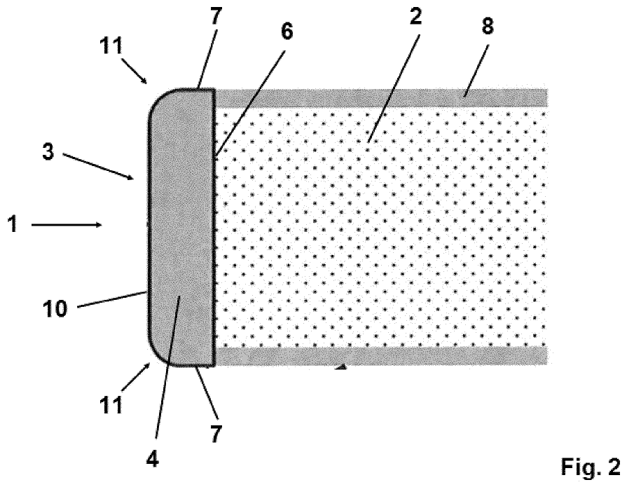

FIG. 2 shows a sectional view of a workpiece coated with the coating material,

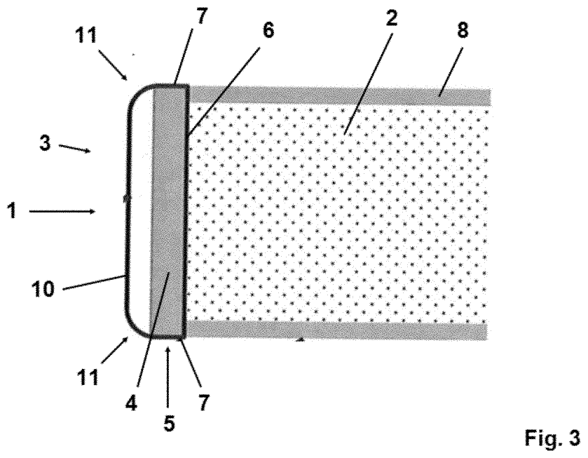

FIG. 3 shows a sectional view of an alternative embodiment of a workpiece coated with the coating material,

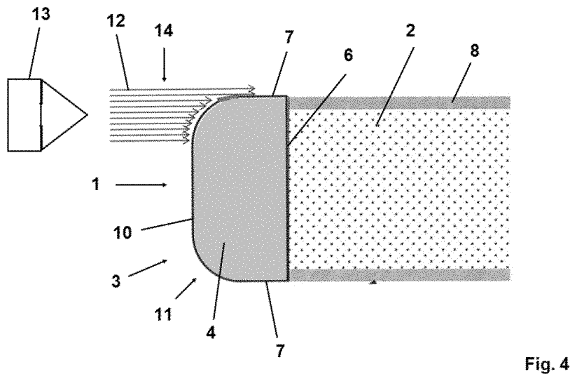

FIG. 4 shows a schematic representation of the coated workpiece during a printing process, and

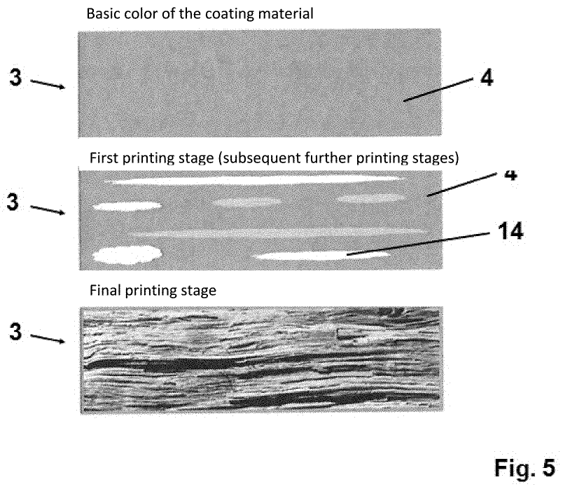

FIG. 5 shows an exemplary representation of the printed coating material in various printing stages of the printing method.

FIG. 1 shows a flow chart of a method for coating a narrow side 1 of a plate-shaped workpiece 2 with a coating material 3. In particular, the narrow side 1 of the workpiece 2 is coated with a strip-shaped or band-shaped coating material 3. Preferably, the coating material 3 is an edge material formed, for example, of a plastic material, wood material or a composite material. The workpiece 2 consists in particular of a wood material, for example a chipboard material.

In a first method step, the plate-shaped workpiece 2 is first brought to a predetermined format, in particular cut or sawed, in a coating apparatus not shown in detail. It can also be provided that a workpiece 2, which has previously been brought to a predetermined format, is fed to the coating apparatus.

Then the coating material 3 is applied to the narrow side 1 of the workpiece 2, wherein a permanent bond between the coating material 3 and the workpiece 2 is formed preferably by an adhesive. Various coating apparatuses and methods are already known for applying the coating material 3 to the workpiece 2. For instance, DE 10 2015 206 010 A1 describes a coating apparatus and a method, by means of which a high-quality coating of the narrow side of the workpiece is made possible.

In the method according to the invention, a coating material 3, which was previously colored with a basic color 4, is fed to the coating apparatus for application to the narrow side 1 of the workpiece 2. The coating material 3 can be entirely colored with the basic color 4, as schematically shown in FIG. 2. Colored means that the basic color 4 is not only applied to the surface of the coating material 3, but that the body of the coating material 3 is at least partially penetrated or colored through by the basic color 4. Likewise, it may be provided that the coating material 3 is colored only in a peripheral area 5 provided adjacent to an adhesive surface 6 of the coating material 3. In particular, side areas 7 of the coating material 3—which are in the visible area when the coating material 3 is applied to the narrow side 1—as a result have the basic color 4. This coloring of the peripheral area 5 is shown in FIG. 3.

The basic color 4 is matched to a shade and/or pattern or decoration of a surface 8 of the workpiece 2. After the coating material 3 has been applied to the narrow side 1 of the workpiece 2, a visually imperceptible or only minimally perceptible color change can thus be formed between the shade and/or pattern and/or decoration of the surface 8 of the workpiece 2 and the basic color 4 of the colored coating material 3, in particular the colored side areas 7 of the coating material 3.

The coating apparatus can be provided with a plurality of coating materials 3 that are colored with different basic colors 4. The basic colors 4 can each be matched, for example, to different shades and/or patterns and/or decorations of workpieces 2 that are processed in the coating apparatus. It may be provided that a coating material 3 having a basic color 4 is used for several shades and/or patterns and/or decorations of the surface 8 of the workpieces 2, which are similar in color or differ only slightly. In this way, a small number of different coating materials 3 with different basic colors 4 can be provided, for example ten different basic colors 4, which can be applied to a plurality of workpieces 2 with different shades and/or patterns and/or decorations. As a result, reduced storage of coating materials 3 can be achieved.

If the coating apparatus is configured to process several coating materials 3, an automated feeding device can be provided which automatically feeds the corresponding coating material 3 to the coating apparatus depending on the shade and/or pattern and/or decoration of the workpiece 2. For example, the coating apparatus may have an optical sensor unit. This detects a shade and/or a pattern and/or decoration of the workpiece 2, so that on the basis of the detected color signal an automated selection is made from the provided coating materials 3 with the suitable basic color 4 and the corresponding coating material 3 is fed to the coating apparatus.

After the coating material 3 has been applied to the narrow side 1 of the workpiece 2, an additional processing or finishing step may be provided in a further method step to form a high-quality coating of the narrow side 1 of the workpiece 2.

In a subsequent method step, the coating material 3 is printed, as shown schematically in FIG. 4. Printing with one or more printing dyes 12 is carried out in particular on a narrow surface 10, which is opposite the adhesive surface 6 of the coating material 3, and on a transition area 11 extending along the narrow surface 10, which merges into one of the side areas 7 of the coating material 3. The transition area 11 can be rounded or chamfered, for example. In particular, a transition area 11 may be provided along both sides of the narrow surface 10.

Before the coating material 3 is printed, pretreatment of the coating material 3, in particular the narrow surface 10 and transition areas 11 to be printed, can occur. This pretreatment may include, for example, cleaning and/or priming, for example applying a primer, of the coating material 3. This allows a durable and visually high-quality dye application to be achieved.

In a further method step, printing of the coating material 3 is carried out by a printing device 13 shown schematically in FIG. 4. The printing device 13 may have a plurality of printing stages, each printing stage comprising a plurality of printing dyes 12. For example, the printing dyes 12 cyan, magenta, yellow and a black component can be provided in each printing stage. Other color gradations, for example light shades, and/or a white printing dye 12 can also be provided. The printing device 13 can either be provided as a separate unit downstream of the coating apparatus or as part of the coating apparatus. This means that printing can take place “inline” in the coating process.

FIG. 5 shows three exemplary illustrations of different printing stages of a printing process on the basis of a fully colored coating material 3. The illustrations each show a top view of the narrow surface 10 of the coating material 3. Before printing, the coating material 3 has the basic color 4 with which the coating material 3 is colored. In the first printing stage, the coating material 3, in particular the narrow surface 10 and, if applicable, the transition areas 11 adjacent to the narrow surface 10, is printed with a first printing dye 12 in several individual printing areas 14. Preferably, the coating material 3 is first printed with the white printing dye 12. If necessary, a different opacity of the printing dye 12 can be provided in the individual areas. This allows different shades or gradations of color to be achieved. Within the first printing stage, this printing process can be repeated with the further printing dyes 12. Advantageously, printing is carried out in several steps, with lighter printing dyes 12 being printed first and progressively darker printing dyes 12 being printed in each of the subsequent steps. Printing with the individual printing dyes 12 in one printing stage can be carried out both step by step, i.e. one after the other, and simultaneously. It may be provided that the various printing dyes 12 at least partially overlap in the printing areas 14.

In the subsequent printing stages, this printing process can be repeated with the respective printing dyes 12, preferably with printing dyes 12 becoming darker in each printing stage. This provides a multi-layer dye application on the coating material 3. In this way, the coating material 3 can be printed with any pattern and/or decoration, for example a representation of a wood structure. An example of such a wood decoration is shown in the lowest illustration according to FIG. 5. The wood decoration printed on the coating material 3 corresponds in particular to a wood decoration which the surface 8 of the workpiece 2 also has.

Within a printing stage and/or between the individual printing stages, an active drying process can also be provided. This enables rapid drying of the printed printing dyes 12.

After printing, the coating material 3 is varnished, at least the narrow surface 10 and/or peripheral areas 11 that are printed with printing dye 12 are varnished. One or more layers of varnish are applied to the coating material 3. The varnish layer or layers can be applied, for example, by a printing process. It may also be provided that the varnishing creates a structured surface. Insofar as the coating material 3 is printed with the representation of a wood structure (cf. FIG. 5), both a visual appearance and a haptic impression of a natural wood surface can be reinforced or created by such a structured varnishing. The varnishing can be followed by another active drying process.

As shown in FIG. 4, the printing device 13 or a print jet 15 of the printing device 13 is advantageously aligned perpendicular to the narrow side 1 of the workpiece 2. Thus, the dye is applied in particular to the narrow surface 10 and the adjacent transition areas 11 of the coating material 3. Since the side areas 7 are arranged parallel to the printing device 13 or the print jet 15, no printing with the printing dyes 12 takes place on the side areas 7. The unprinted side areas 7 of the coating material 3 as a result have the basic color 4 also after the narrow surface 10 and the transition areas 11 have been printed. Since this basic color 4 is color-matched to the shade of the pattern and/or decoration printed on the coating material 3 and/or the surface 8 of the workpiece 2, no color difference or only a slight color difference can be perceived between the coating material 3 and the surface 8 of the workpiece 2. Thus, the method forms a visually smooth or seamless color transition from the coating material 3 to the surface 8 of the workpiece 2. This conveys the visual impression that the workpiece 2 is formed from a uniform material, e.g. solid wood. Full printing of the coating material 3 by the printing device 13, i.e. of the narrow surface 10, the transition areas 11 as well as the side areas 7, is therefore not necessary in this coating method. An additional multi-axis adjustment mechanism for the printing device 13 can thus be omitted.

### LIST OF REFERENCE NUMBERS

1. Narrow side
2. Workpiece
3. Coating material
4. Basic color
5. Peripheral area
6. Adhesive surface
7. Side area
8. Surface
10. Narrow surface
11. Transition area
12. Printing dye
13. Printing device
14. Printing area
15. Print jet

1. Method for coating a narrow side (1) of a plate-shaped workpiece (2) with a coating material (3), in particular a strip-shaped or band-shaped coating material (3), using a coating apparatus,
characterized in that
before being applied to the narrow side (1) of the workpiece (2), the coating material (3) is colored with a basic color (4) at least in a peripheral area (5), which is assigned to an adhesive surface (6) of the coating material (3), or the coating material (3) is entirely colored with the basic color (4), wherein the basic color (4) is color-matched to a shade and/or pattern and/or decoration of a surface (8) of the workpiece (2) such that, after the coating material (3) has been applied to the narrow side (1) of the workpiece (2), a homogeneous color transition between the colored coating material (3) and the shade and/or pattern and/or decoration of the surface (8) of the workpiece (2) is formed.

2. Method according to claim 1,
characterized in that
before being fed to the coating apparatus, the coating material (3) is colored with the basic color (4) or the coating material (3) is colored with the basic color (4) by a coloring device of the coating apparatus.

3. Method according to claim 1,
characterized in that
the coating apparatus is provided with a plurality of coating materials (3) colored with different basic colors (4), wherein one of the coating materials (3) whose basic color (4) is color-matched to the shade and/or pattern and/or decoration of the surface (8) of the workpiece (2) is fed to the coating apparatus for coating the narrow side (1) of the workpiece (2).

4. Method according to claim 1,
characterized in that
after application to the narrow side (1) of the workpiece (2), the coating material (3), in particular a narrow surface (10) opposite the adhesive surface (6) and extending along the coating material (3) and/or at least one transition area (11) of the coating material (3) extending along the narrow surface (10), is printed with a printing device (13) having at least one printing stage.

5. Method according to claim 4,
characterized in that
the coating material (3) is printed inline in the coating device with the printing device (13) and an active drying process of the printing dyes (12) applied to the coating material (3) occurs preferably after each printing stage.

6. Method according to claim 1,
characterized in that
the shade and/or pattern and/or decoration of the surface (8) of the workpiece (2) is detected by a sensor device, and a coating material (3) with a color-matched basic color (4) is automatically fed to the coating apparatus based on the detected shade and/or pattern and/or decoration, and/or the printing device (13) is controlled by the sensor device such that the coating material (3) is printed with a pattern and/or decoration which is matched to the detected shade and/or pattern and/or decoration.

7. Coating apparatus for coating a narrow side (1) of a plate-shaped workpiece (2) with a coating material (3), in particular a strip-shaped or band-shaped coating material (3), using a feeding device for feeding the coating material (3) to the narrow side (1) of the workpiece (2) and a coating unit for applying the coating material (3) to the narrow side (1) of the workpiece (2),
characterized in that the coating apparatus carries out the method according to claim 1.
